(19) United States
(12) Patent Application Publication
(10) Pub. No.: US 2020/0026502 A1
(43) Pub. Date: Jan. 23, 2020

(54) METHOD AND SYSTEM FOR DETERMINING INEFFICIENCIES IN A USER INTERFACE

(71) Applicants: Michael Moore, West Nyack, NY (US); Amit Soni, Madison Hts., MI (US)

(72) Inventors: Michael Moore, West Nyack, NY (US); Amit Soni, Madison Hts., MI (US)

(21) Appl. No.: 16/517,346

(22) Filed: Jul. 19, 2019

Related U.S. Application Data
(60) Provisional application No. 62/700,356, filed on Jul. 19, 2018.

(51) Int. Cl. G06F 8/38; G06F 11/34; G06F 11/36

(52) U.S. Cl. CPC G06F 8/38; G06F 11/3476; G06F 11/3664; G06F 11/3612; G06F 11/3438

(57) ABSTRACT

A method for assessing the efficiency of a graphic user interface, comprising; recording, by one or more processors, a set of user's actions within a graphic user interface; analyzing, by one or more processors, the recorded user actions, wherein the recorded user actions are analyzed to locate inefficiencies in the user actions relative to a baseline set of actions; identifying, by one or more processors, an inefficiency of the user actions when compared to the baseline set of actions; identifying, by one or more processors, at least one alteration to the graphic user interface based on the identified inefficiency; and creating, by one or more processors, at least one new solution corresponding to the identified inefficiency in the graphic user interface, each new solution is created by altering at least one aspect of the graphic user interface, thereby creating a new layout of the graphic user interface.

### CROSS-REFERENCE TO RELATED APPLICATIONS

This application is a continuation of U.S. application No. 62/700,356 filed Jul. 19, 2018. The disclosure of the prior applications is considered part of (and is incorporated by reference in) the disclosure of this application.

### BACKGROUND

This disclosure relates generally to user interface efficiency, and more specifically to a method, computer program and computer system for determining user interface efficiency based on user input and tracking the user through their use of the interface.

User interfaces are deployed on applications and programs such as web browsers, email programs, machinery, and operating systems for computer and mobile devices. Generally, user interfaces enable users to control and operate devices to produce a desired result. Specifically, user interfaces may include a set of commands and menus to communicate with applications and programs. As such, user interfaces are typically designed for efficiency and ease of operation. Furthermore, user interface design requires an understanding of user needs and of the functionality required by the system to accomplish the user needs. Therefore, different phases or processes may be involved in user interface design and may include such processes as user and task analysis, information architecture, prototyping, simulation, and usability testing to test the performance of the user interface.

Users interact with an application via a user interface through which the users can each initiate a series of actions in an attempt to achieve a desired goal. User satisfaction with an application can be affected by the efficiency of its user interface. The easier a user finds it to achieve a desired result, the more pleased the user is with the application. In other words, an efficient user interface can draw more users to a given application as well as make them more productive when using the application.

Publishers, in a drive to increase user satisfaction, attempt to understand how various design features affect user perception of a page. Publishers also want to mitigate the risk associated with introducing new page designs. Publishers use a number of approaches to mitigate risk, such as collecting live statistics, conducting surveys, running usability studies, performing eye-tracking studies. However, none of the approaches attempt to measure how efficiently users process information on a page. In other words, none of the approaches measures the cognitive efficiency of a page.

A common metric for informational and navigational pages is how much time a user spends at each. A designer of an informational page strives to maximize the time a user spends on the page. Prolonged time indicates that the page's content is of interest. However, for navigational pages, time spent on the page should be minimized, so that the user is able to move to the intended destination as quickly as possible.

Therefore, it is desired for a method, computer program, or computer system to track a user's interaction with an interface to determine the efficiency of the interface, and also assist in providing modifications to the interface to resolve the inefficiencies with the user and with the design and layout of the user interface.

### SUMMARY

[Final Step Completed by Attorney]

In a first embodiment, the present invention is a method for assessing the efficiency of a graphic user interface, comprising: recording, by one or more processors, a set of user's actions within a graphic user interface; analyzing, by one or more processors, the recorded user actions, wherein the recorded user actions are analyzed to locate inefficiencies in the user actions; identifying, by one or more processors, an inefficiency of a graphical user interface based on the inefficiencies in the user actions; identifying, by one or more processors, at least one alteration to the graphic user interface based on the identified inefficiency; and creating, by one or more processors, at least one new solution corresponding to the identified inefficiency in the graphic user interface, each new solution is created by altering at least one aspect of the graphic user interface, thereby creating a new layout of the graphic user interface.

In a second embodiment, the present invention is a computer program product for assessing the efficiency of a graphic user interface, comprising: one or more computer readable storage media and program instructions stored on the one or more computer readable storage media, the program instructions comprising: program instructions to record a set of user's actions within a graphic user interface; program instructions to analyze the recorded user actions, wherein the recorded user actions are analyzed to locate inefficiencies in the user actions; program instructions to identify an inefficiency of a graphical user interface based on the inefficiencies in the user actions; program instructions to identify at least one alteration to the graphic user interface based on the identified inefficiency; and program instructions to create at least one new solution corresponding to the identified inefficiency in the graphic user interface, each new solution is created by altering at least one aspect of the graphic user interface, thereby creating a new layout of the graphic user interface.

In a third embodiment, the present invention is a computer system product for assessing the efficiency of a graphic user interface, comprising: one or more computer processors, one or more computer readable storage media, and program instructions stored on the one or more computer readable storage media for execution by, at least one of the one or more processors, the program instructions comprising: program instructions to record a set of user's actions within a graphic user interface; program instructions to analyze the recorded user actions, wherein the recorded user actions are analyzed to locate inefficiencies in the user actions; program instructions to identify an inefficiency of a graphical user interface based on the inefficiencies in the user actions; program instructions to identify at least one alteration to the graphic user interface based on the identified inefficiency; and program instructions to create at least one new solution corresponding to the identified inefficiency in the graphic user interface, each new solution is created by altering at least one aspect of the graphic user interface, thereby creating a new layout of the graphic user interface.

### BRIEF DESCRIPTION OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 depicts a computing environment, in accordance with an embodiment of the present invention.

FIG. 5 depicts a flowchart of the operational steps taken by a collection module, in accordance with an embodiment of the present invention.

FIG. 6 depicts a flowchart of the operational steps taken by a design module, in accordance with an embodiment of the present invention.

FIG. 7 depicts a flowchart of the operational steps, in accordance with another embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

Many companies today regulate the creation of user interfaces for their products, for example through guidelines or other rules or that apply to graphical user interfaces (GUI). The guidelines may stem from a desire to make the GUI user-friendly, from a technical restriction in the implemented system, to name a few examples. The desire to make the GUI user-friendly assists the user (or employee) in being efficient and effective with their time when completing tasks. However, in real work situations, the GUI may not be as user-friendly as initially thought, or the GUI may not work well with the specific employee or the customer who the employee is working with. Many of these issues are difficult or impossible to expect when creating the GUI. So, a system to test the employee in their day-to-day operations with the GUI and the employee's interaction with the GUI with customers is an on-going process which needs constant monitoring. This monitoring and testing allow the companies to identify inefficiencies with the GUI and/or the employee. To provide updates to the GUI or to develop training material for the employee.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

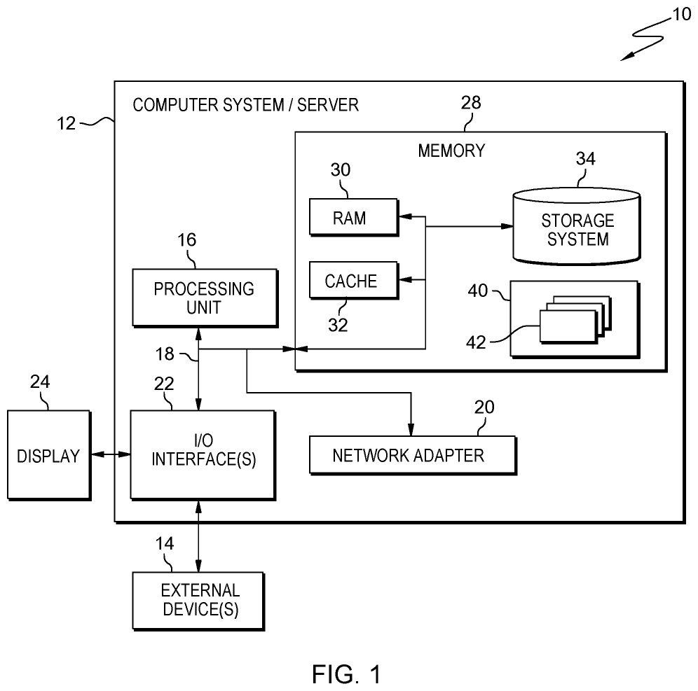

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purposes or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

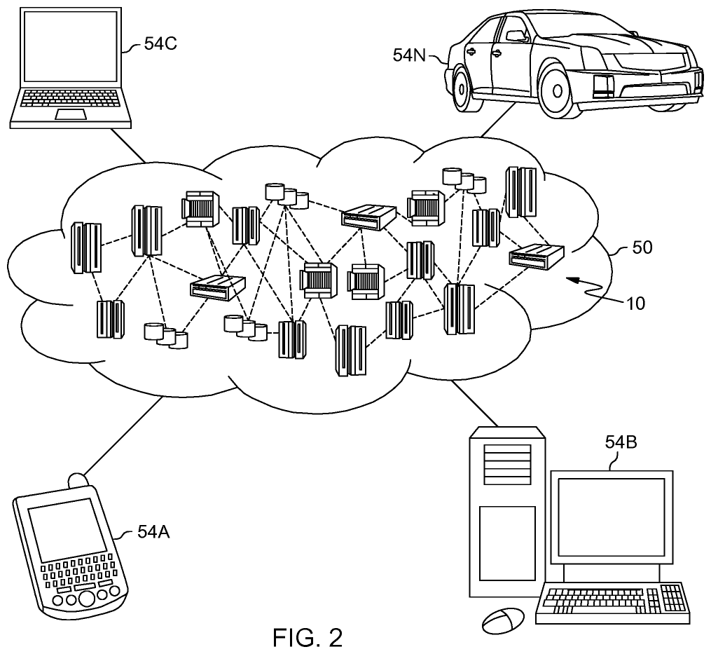

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

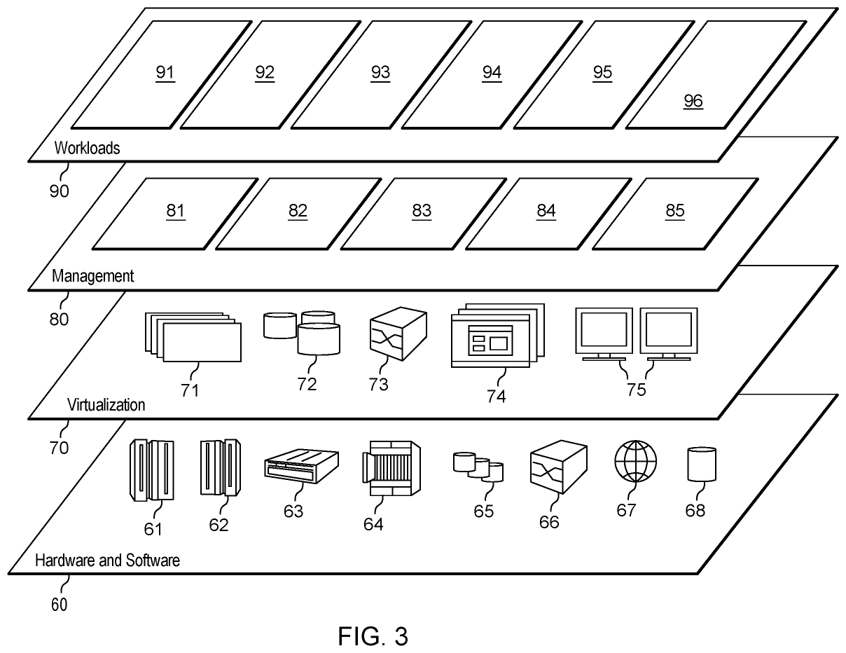

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 include hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: audio processing 91; software development and lifecycle management 92; action review 93; data analytics processing 94; transaction processing 95; or comparison processing 96.

Referring back to FIG. 1, the Program/utility 40 may include one or more program modules 42 that generally carry out the functions and/or methodologies of embodiments of the invention as described herein. Specifically, the program modules 42 may monitor real-time parking facility camera data, receive vehicle identification information for a vehicle entering a parking facility, identify driver and vehicle information based on the vehicle identification information, identify open parking spaces based on the real-time parking facility camera data, determining attributes of the open parking spaces, score the open parking spaces based on the attributes, the vehicle information, and the driver information, select a particular open parking space based on the scoring, determine navigation directions to the selected parking space, and outputting navigation directions and information for the selected parking space, e.g., to a user device of the driver and/or to a vehicle interface system, such as a vehicle navigation system. Other functionalities of the program modules 42 are described further herein such that the program modules 42 are not limited to the functions described above. Moreover, it is noted that some of the modules 42 can be implemented within the infrastructure shown in FIGS. 1-3.

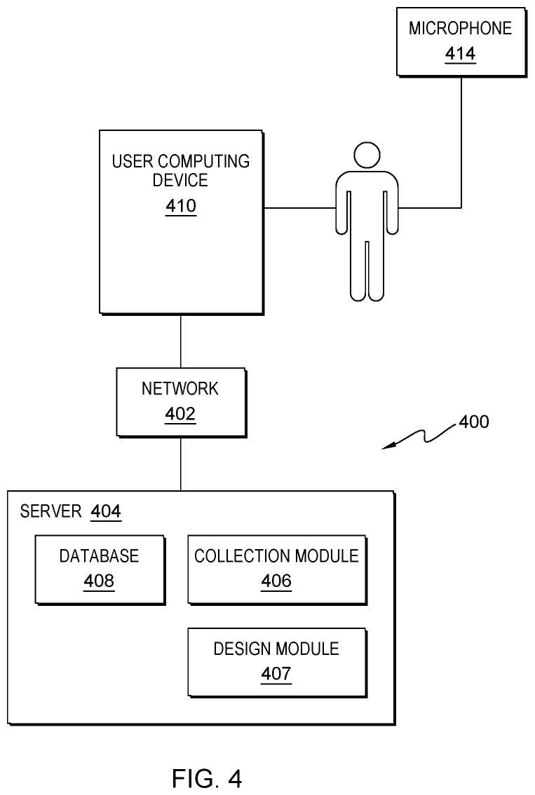

FIG. 4 depicts a block diagram of a computing environment 400 in accordance with one embodiment of the present invention. FIG. 1 provides an illustration of one embodiment and does not imply any limitations regarding the viewable environment in which different embodiments maybe implemented.

Particularly, the environment 400 integrates with a GUI engine that a GUI designer and infrastructure developer can use. The modification or alteration to the GUI can be accomplished with the results of the present method, or training materials could be generated with the results of the present method. For exemplary purposes, the GUI engine manages the GUI layouts, GUI principles and GUI taxonomies, and can also handle GUI environments, GUI styles, GUI patterns and GUI topologies.

In the depicted embodiment, computing environment 400 includes network 402, user computing device 410, and server 404. Computing environment 400 may include additional servers, computers, or other devices not shown.

Network 402 may be a local area network (LAN), a wide area network (WAN) such as the Internet, any combination thereof, or any combination of connections and protocols that can support communications between user computing device 410 and server 404 in accordance with embodiments of the invention. Network 402 may include wired, wireless, or fiber optic connections.

User computing device 410 may be a management server, a web server, or any other electronic device or computing system capable of processing program instructions and receiving and sending data. In some embodiments, user computing device 410 may be a laptop computer, tablet computer, netbook computer, personal computer (PC), a desktop computer, or any programmable electronic device capable of communicating with projector 112 and server 404 via network 402. In other embodiments, user computing device 410 may represent a server computing system utilizing multiple computers as a server system, such as in a cloud computing environment. In another embodiment, user computing device 410 represents a computing system utilizing clustered computers and components to act as a single pool of seamless resources. In some embodiments, user computing device 410 may include any combination of database 408, design module 406, and projected image display module 107. user computing device 410 may include components, as depicted and described in further detail with respect to FIG. 1. In the depicted embodiment a microphone 114 is connected to the user computing device 410 to collect audio and visual data related to the user. In other embodiments, various other peripherals based on the desired type of data to be collected.

Server 404 may be a management server, a web server, or any other electronic device or computing system capable of processing program instructions and receiving and sending data. In another embodiments server 404 may be a laptop computer, tablet computer, netbook computer, personal computer (PC), a desktop computer, or any programmable electronic device capable of communicating via network 402. In one embodiment, server 404 may be a server computing system utilizing multiple computers as a server system, such as in a cloud computing environment. In one embodiment, server 404 represents a computing system utilizing clustered computers and components to act as a single pool of seamless resources. In the depicted embodiment database 408, design module 406 is located on server 404. Server 404 may include components, as depicted and described in further detail with respect to FIG. 1.

Collection module 406 assists with the collection of the data (e.g. user's actions) and sorts the collected data to allow for the design module 407 to process and analyze the data. The collection module 406 is able to be integrated into the various systems or programs used by the user or are able to externally view the user's actions. Through the ability to record the user's various actions with the GUI and with the customer, the collection module 406 is able to collect the various pieces of data which are relevant to assist the design module 407 in proposing alterations to the GUI. In the depicted embodiment, the collection module 406 resides on server 404. In one embodiment, collection module 406 resides on user computing device 410. In other embodiments, collection module 406 may be located on another server or computing device, provided collection module 406 has access to database 408, user computing device 410, microphone 114, and design module 407.

Design module 407 determines where there are inefficiencies (or efficiencies) with the GUI or the user and provides alterations or alternatives to assist the user increasing their efficiency. Either through the layout of the GUI, how the user interacts with the GUI, how the GUI processes from one page or procedure to the next, and the other aspects of the GUI that would affect the speed and efficiency at which the user can process through the procedure they are attempting to complete. The design module 407 also is able to receive audio and video data and compare this with the user's actions with the GUI to determine if, for example, the user is correctly using the GUI based on a conversation with a client or customer. In the depicted embodiment, the Design module 407 resides on server 404. In one embodiment, Design module 407 resides on user computing device 410. In other embodiments, Design module 407 may be located on another server or computing device, provided Design module 407 has access to database 408, user computing device 410, microphone 114, and collection module 406.

Database 408 may be a repository that may be written to and/or read by user computing device 410 and design module 406. In one embodiment, database 408 is a database management system (DBMS) used to allow the definition, creation, querying, update, and administration of a database(s). In the depicted embodiment, database 408 resides on server 404. In other embodiments, database 408 resides on another server, or another computing device, provided that database 408 is accessible to user computing device 410, collection module 406 and the design module 407.

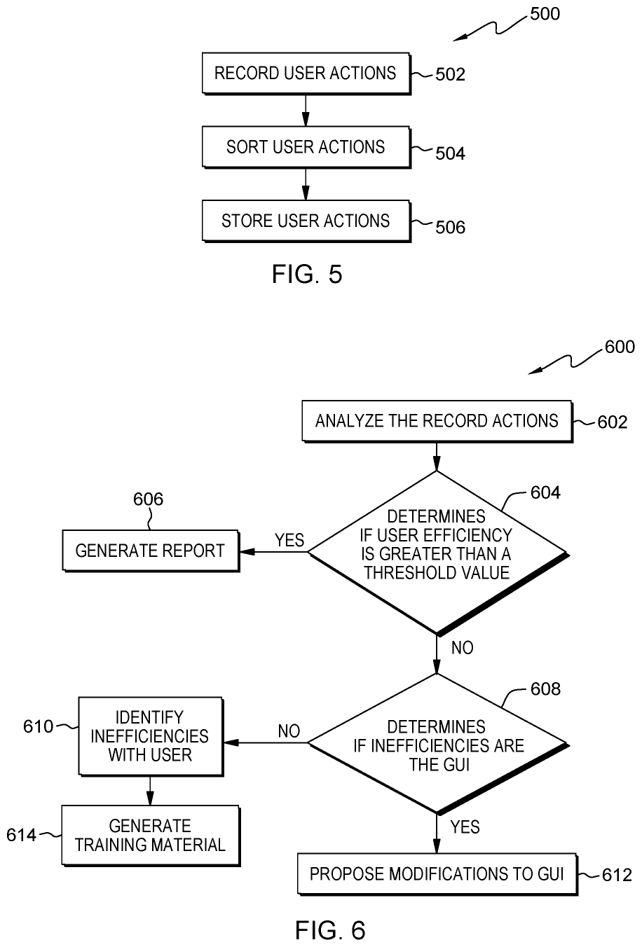

FIG. 5 shows flowchart 500 depicting a method according to the present invention. The method(s) and associated process(es) are now discussed, over the course of the following paragraphs, with extensive reference to FIG. 4, in accordance with one embodiment of the present invention.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature. The collection module 406 advanced observation technology provides the ability to view, record, and sort the user's actions with the GUI and the customers.

In step 102, the design module 406 records user's metrics and actions (and lack of action). The collection module 406 is able to record all the user's actions with the computing device, for example, the user's keystrokes, movement of the mouse (or other peripheral devices), and their progression through the various sections of the GUI and their selections within those sections. Where a microphone is used the design module 406 is able to collect data from these peripherals, and in some instances is able to capture audio from the customer, or the person the user is speaking or interacting with. The design module 406 records the user through a specific time period based on either the length of meeting/call or through a certain section of the GUI. The design module 406, in some embodiments, is instructed to record specific user actions. In some embodiments the design module 406 has a set of triggers, wherein when a trigger is activated the design module 406 begins to record the user's actions. In some instances an external program or application may be used to record the user's actions. For example, a cloud-based business intelligence and analytics platforms.

The collection module 406 is designed to work with various external systems and can be integrated into existing platforms. For example, the collection module 406 is able to record various customer relationship management tools, various types of management systems, and can be integrated into other applications that are specific to the user. Examples of types of actions which are recorded is, but not limited to, product subscription/cancellations, placing of orders, renewal of subscriptions, customer complaints, account inquires/upgrades/closures, bill payments, and various other customer requests. The collection module 406 may also be implements in situations where it is an employee to customer, employee to employee, or the employee by themselves using the GUI.

The metrics are associated with specific actions or techniques which are required to be performed by the user to successfully navigate the GUI. This may include, but not limited to, how they process through the GUI given a specific situation, their use of the interface for efficiency, problems that frequently occur based on the user interface (e.g. miss clicks or incorrect processing), may include the user's interaction with a customer (e.g. tone, articulation, helpfulness, and the like), average handle time of a call with a customer, customer satisfaction, sales per hour, revenue per hour, conversion rate of customer calls, gross conversion rate over a predetermined time period, eligible sales conversion rate, quality assurance score, escalation rate, save rate, saved customer revenue rate, and the like.

The design module 406 is able to record the user's actions in video or still image formats, along with audio through screen scraping, terminal emulation, a process similar to screen scraping or performance trackers to record any and all (as well as a predetermined set of) actions of the user. In an embodiment where screen scraping is being implemented, the design module 406 collects screen display data from the application and translate this information to another application for display and analyzing purposes. For example, these actions could include, but not limited to the user's interaction with the GUI, the user's processing through windows (or screens), the user's action and reaction to the GUI, or the like. In additional embodiments, the design module 406 records user actions based on meta data embedded in the GUI the user is using. The meta data is embedded for the purpose of tracking the user's progression through the GUI or specific processes to better understand the exact and specific actions the user is taking. This data is stored in a predetermined location and accessed for the future steps. The data may be gathered continuously or through a predetermined time frame.

In step 504, the collection module 407 sorts the user's actions into different categories. The collection module 406 takes the recorded actions and sorts them based on the different metrics and areas which are to be analyzed by the design module 406. The sorting of the data maybe, but not limited to, the activities, the duration of the activities, number of clicks, navigation sequences, keystrokes, and the like. Based on the design module 406, the collection module 407 is able to categorize the data to allow for easier access.

In step 506, the collection module 406 stores the user's actions in a database which is accessible to design module 406.

FIG. 6 shows flowchart 600 depicting a method according to the present invention. The method(s) and associated process(es) are now discussed, over the course of the following paragraphs, with extensive reference to FIG. 4, in accordance with one embodiment of the present invention.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The design module 406 advanced observation technology provides insights to both the GUI which the user works with, but also how the user interacts with GUI in real-world situations. Through the monitoring of both the specific actions of the user with the GUI and the user interaction with the customer. The design module 406 provides insight into the employee and the GUI inefficiencies and also where the employee and GUI is efficient. The design module 406 is able to detect inefficiencies with either the GUI or the user's interaction with the GUI

In step 602, the design module 406 analyzes the recorded data of the user's interaction with the GUI, the program pressions, and/or customer to determine the usability issues with the GUI. The recorded data is analyzed to determine areas of the GUI or the user's progression through the GUI (through windows or screens) and interaction with the customer to determine the specific actions of the user to determine either inefficiencies, efficiencies, or both. For example, the design module 406 is able to compare the audio of the phone call to the section of the GUI the user is interacting with to confirm that the user is at the correct section based on the conversation. Additionally, the design module 10 analyzes for speed of processing through the GUI, user errors regarding inputting data, or having to return to previous sections. In some embodiments, the inefficiencies may be based on the distance a user has to scroll across the interface, or if the user has to process to sections out of order. The progression of the GUI based on the user interaction is also recorded. The design module 406 analyzes the design of the GUI, the setup of the GUI, and the various features and functions independently of the user's actions within the GUI.

For example the design module 406 analyzes the GUI to determine the design and setup of the GUI, the user's ease to navigate through the GUI, the order of selecting an option or searching for the next sequential action, and other actions which show that the user is either unaware of what to do, is crossing a large area of the user interface, miss clicks, or the like. The design module 406 also tracks efficient areas of the GUI based on data collected from the user that show quick and efficient progression from one step to the next.

The processing of the data may be related to various metrics which the design module 406 is requested to review. Such as, but not limited to, predetermined sequence of activities compared to the recorded sequence of activities, the predetermined time duration for activities compared to the record time duration for activities, the predetermined number of clicks to complete the activities, the predetermined navigation sequence compared to the record navigation sequence, the predetermined length of activities compared to the recorded length of activities (e.g. timestamps at each milestone), and the key performance indicator (KPI). The KPI may be based on previously determined goals and objectives which direct the design module 406 to specific metrics to identify and analyze and may be based on critical success factors (CSF).

In decision 604, the design module 406 determines if the user is efficiently interacting with the GUI. The design module 406 determines if the user is efficiency interacting with the GUI. The threshold value may be related to the actions taken by the user to complete a specific task within a predetermined time limit, or within a predetermined number of actions (key strokes or icon selections), a comparison of the audio/video and the user's actions and how closely the coincide, or other aspects of the user's interaction with the GUI or the customer. These inefficiencies with the user may not be issues which are results of the user interface, but with the user. This determination maybe made based on a predetermined value of the acceptable number of errors encountered by the design module 406 of the user's actions. The determination may be made based on the multiple comparisons listed above which were analyzed in step 602. For example, if the majority of users are able to correctly perform the action in a predetermined or within an average time, but one user is unable to complete the process. It is likely not an issue with the user interface, but with that one user. If the design module 406 determines that the user is the operating within the threshold values/limits (YES branch, proceed to step 606) the design module 406 generates a report based on the user's actions. If the design module 406 determines that the user is not within the threshold value/limits (NO branch, proceed to step 608) the design module 406 determines if the inefficiencies are the user.

In step 606, the design module 406 generates a report. The report identifies the actions of the user to highlight areas of efficiency and inefficiency. The report, may, include tutorials for the user based on the specific areas or metrics where inefficiencies were discovered. The tutorial may be connected to various tutorials or educational documents to assist the user in increasing performance in specific areas as identified in step 614.

In decision 608, the design module 406 determines if there are inefficiencies with the GUI. The inefficiencies with the GUI may be based on, but not limited to, the navigation sequences, required number of clicks, required activities, and the overall design/layout of the GUI. The design module 406 is able to analyze the record actions and compare the actions of the user with other users to determine where the inefficiencies are. The design module 406 is able to determine if the user is the cause for the inefficiencies from being distracted, not knowing how to properly navigate the GUI, issues with the customer, or the like. This is typically identified by at least one user having an efficient interaction with the GUI, where the current user who is experiencing inefficiencies does not fall within the threshold values. If the design module 406 determines that the GUI is the cause of the inefficiency (YES branch, proceed to step 612) the design module 406 analyzes the recorded actions to determine the inefficiencies with the GUI. If the design module 406 determines that the GUI is not the cause of the inefficiency (NO branch, proceed to step 610) the design module 406 identifies inefficiencies with the user.

In step 610, the design module 406 identifies the inefficiencies with the user. Through the measuring of the predetermined values to the recorded values and comparing the user's actions to those of other users. The design module 406 is able to identify the inefficiencies with the specific user. Through the analyzed recorded actions in step 602, the design module 406 is able to pinpoint the specific areas where the user is able to receive high levels of improvement with minimal changes.

In step 612, the design module 406 proposes modifications or alterations to the GUI to overcome the inefficiencies detected. These modifications or alterations may be to location of the various inputs and outputs, the section order, the options available to the user, or the like. Through the analyzed recorded actions in step 102 and the comparison of the predetermined values vs. recorded values, the design module 406 is able to identify modifications that would improve the CSF score and thus the KPI through minor or major alterations. The design module 406 may use artificial intelligence (AI) models or computer learning technology to analyze the recorded actions and determine potential outcomes or alterations to the GUI. An AI model as used includes, but is not limited to, neural networks such as recurrent neural networks, recursive neural networks, feed-forward neural networks, convolutional neural networks, deep belief networks, and convolutional deep belief networks; multi-layer perceptrons; self-organizing maps; deep Boltzmann machines; and stacked de-noising auto-encoders.

Through the computer aided design alterations, the user is able to see the modifications to the design. In some embodiments, the user is able to interact with the altered design to determine if the alterations are an improvement over the previous GUI. The design module 406 may alter the layout of specific sections or screens of the GUI. In some embodiments, the design module 406 identifies the cause of the inefficiency and the proposed benefits of the altered layout. The solution may be an average of each user's data sets. In additional embodiments, the solution may be directed towards each specific user. In some embodiments, the design module 406 proposes the modification to the GUI. In other embodiments, the design module 406 implements the modification to the GUI automatically.

In some embodiments, the suggested or implemented solutions are viewable from a user, supervisor, or executive viewpoint. This provides multiple examples of the alterations and allows for the input from various positions to determine if the changes are appropriate, adequate, and desired by all levels within the organization.

The implementation process may be automatic, or user approved for the implementation of the improved GUI layout which is provided based on the analyzed data. In some embodiments, the solution is automatically populated into the GUI. In other embodiments, the design module 406 may request approval for the modification to be implemented.

The initial selection of one of the identified suggested improvements is received and implemented. In some instances, the initial selection may comprise the selection of the section of the GUI that is indicated as the inefficient section, or another similar indication within the GUI associated with the inefficiencies. In some instances, a mouse-over gesture or mouse-click on a particular one of the suggested improvements may be received to indicate the initial selection of the suggested improvement. Any suitable methods of identifying the suggested improvement may be used in a particular implementation, including any particular method of user input including the use of a touch screen, a keyboard, a voice command, a mouse gesture, or a multi-touch gesture.

In step 612, the design module 406 generates a training module specific to the user based on the user inefficiencies. The inefficiencies of the user may be due to their lack of understanding of the software, the GUI, or various other factors which resulted in their inefficient use of the GUI. In some embodiments, the design module 406 is able to locate a previously generated or created training material based on the user's inefficiencies and supply the previously created training materials to the user.

The design module 406 may generates a tutorial for the user, based on the identified issue(s) associated with the user. The design module 406 may create a user specific training tutorial or locates a tutorial associated with the given issue the user is encountering. These tutorials are presented to the user and allow the user to practice known solutions to their problem. They may be interactive tutorials, videos, reports, or the like depending on the program or the prefabricated tutorials.

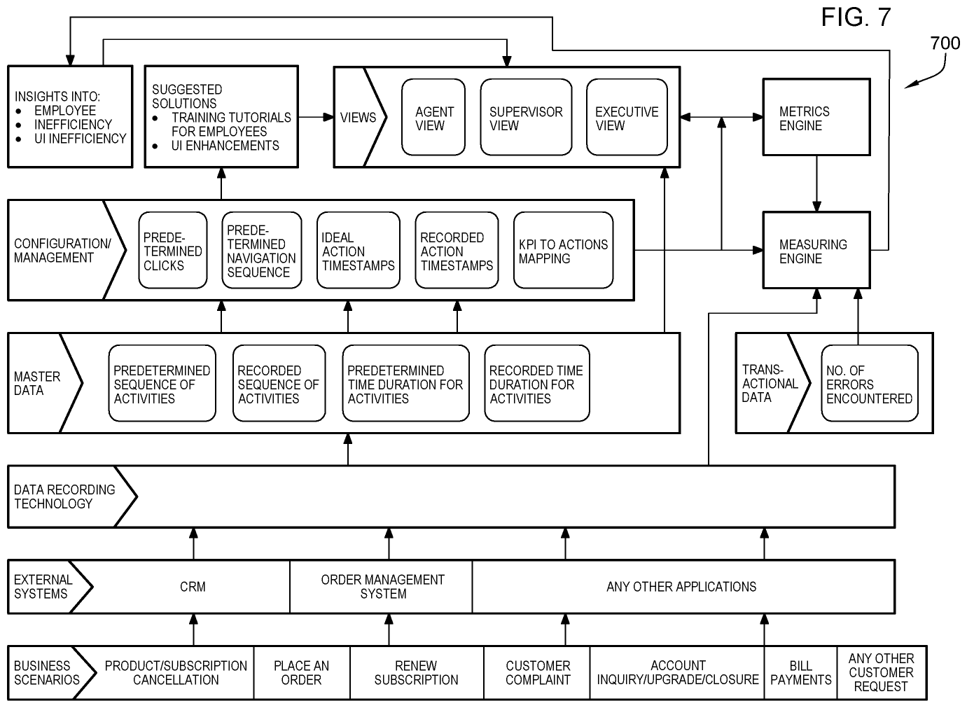

FIG. 7 depicts a flowchart 700 of the operational steps, in accordance with another embodiment of the present invention. The steps outline in FIG. 6 are depicted in a specific embodiment showing a detailed flow through the process. Where business scenarios and specific external systems are used with a third-party data recording technology. This data is them supplied to a measuring engine and integrated into a set of master data which is comparing a predetermined value to the record value of various characteristics of the user's performance (e.g. sequence of activities, time duration for activities, and the like). The measuring engine also receives the number of errors recorded and processes the data which is used to produce the employee inefficiencies. The master data is used then used with the configuration management system to analyze another set of specific factors (e.g. clicks, action time stamps, mapping, navigation sequence and the like.) related to the recorded data to assist in producing the training tutorials. These training tutorials are then produced in several embodiments based on the intended viewer of the tutorial.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A method for assessing the efficiency of a graphic user interface, comprising:
recording, by one or more processors, a set of user's actions within a graphic user interface;
analyzing, by one or more processors, the recorded user actions, wherein the recorded user actions are analyzed to locate inefficiencies in the user actions;
identifying, by one or more processors, an inefficiency of a graphical user interface based on the inefficiencies in the user actions;
identifying, by one or more processors, at least one alteration to the graphic user interface based on the identified inefficiency; and
creating, by one or more processors, at least one new solution corresponding to the identified inefficiency in the graphic user interface, each new solution is created by altering at least one aspect of the graphic user interface, thereby creating a new layout of the graphic user interface.

2. The method of claim 1, further comprising:
identifying, by one or more processors, that the inefficiency is caused the user, wherein it is determined the user actions are below a threshold value compared to the baseline set of actions.

3. The method of claim 2, further comprising:
generating, by one or more processors, a tutorial, wherein the tutorial identifies specific actions based on the identified inefficiencies in the user actions.

4. The method of claim 1, further comprising:
recording, by one or more processors, an interaction between two parties; and
comparing, by one or more processors, the recorded interaction between two parties and the user actions relative to the graphic user interface.

5. The method of claim 1, further comprising:
identifying, by one or more processors, an inefficiency with the user actions.

6. The method of claim 5, further comprising:
proposing, by one or more processors, a set of solution actions to the identified inefficiency with the user actions.

7. A computer program product for assessing the efficiency of a graphic user interface, comprising:
one or more computer readable storage media and program instructions stored on the one or more computer readable storage media, the program instructions comprising:
program instructions to record a set of user's actions within a graphic user interface;
program instructions to analyze the recorded user actions, wherein the recorded user actions are analyzed to locate inefficiencies in the user actions;
program instructions to identify an inefficiency of a graphical user interface based on the inefficiencies in the user actions;
program instructions to identify at least one alteration to the graphic user interface based on the identified inefficiency; and
program instructions to create at least one new solution corresponding to the identified inefficiency in the graphic user interface, each new solution is created by altering at least one aspect of the graphic user interface, thereby creating a new layout of the graphic user interface.

8. The computer program product of claim 7, further comprising:
program instructions to identify that the inefficiency is caused the user, wherein it is determined the user actions are below a threshold value compared to the baseline set of actions.

9. The computer program product of claim 8, further comprising:
program instructions to generate a tutorial, wherein the tutorial identifies specific actions based on the identified inefficiencies in the user actions.

10. The computer program product of claim 7, further comprising:
program instructions to record an interaction between two parties; and
program instructions to compare the recorded interaction between two parties and the user actions relative to the graphic user interface.

11. The computer program product of claim 7, further comprising:
program instructions to identify an inefficiency with the user actions.

12. The computer program product of claim 11, further comprising:
program instructions to propose a set of solution actions to the identified inefficiency with the user actions.

13. A computer system product for assessing the efficiency of a graphic user interface, comprising:
one or more computer processors, one or more computer readable storage media, and program instructions stored on the one or more computer readable storage media for execution by, at least one of the one or more processors, the program instructions comprising:
program instructions to record a set of user's actions within a graphic user interface;
program instructions to analyze the recorded user actions, wherein the recorded user actions are analyzed to locate inefficiencies in the user actions;
program instructions to identify an inefficiency of a graphical user interface based on the inefficiencies in the user actions;
program instructions to identify at least one alteration to the graphic user interface based on the identified inefficiency; and
program instructions to create at least one new solution corresponding to the identified inefficiency in the graphic user interface, each new solution is created by altering at least one aspect of the graphic user interface, thereby creating a new layout of the graphic user interface.

14. The computer system of claim 13, further comprising:
program instructions to identify that the inefficiency is caused the user, wherein it is determined the user actions are below a threshold value compared to the baseline set of actions.

15. The computer system of claim 14, further comprising:
program instructions to generate a tutorial, wherein the tutorial identifies specific actions based on the identified inefficiencies in the user actions.

16. The computer system of claim 13, further comprising:
program instructions to record an interaction between two parties; and
program instructions to compare the recorded interaction between two parties and the user actions relative to the graphic user interface.

17. The computer system of claim 13, further comprising:
program instructions to identify an inefficiency with the user actions.

18. The computer system of claim 17, further comprising:
program instructions to propose a set of solution actions to the identified inefficiency with the user actions.
